(19) United States
(12) Patent Application Publication
(10) Pub. No.: US 2025/0113900 A1
(43) Pub. Date: Apr. 10, 2025

(54) BUCKLE PART AND METHOD OF PRODUCING THE SAME

(71) Applicant: YKK CORPORATION, Tokyo (JP)

(72) Inventor: Kenichiro YOKOYAMA, Kurobe-shi (JP)

(21) Appl. No.: 18/909,826

(22) Filed: Oct. 8, 2024

(30) Foreign Application Priority Data
Oct. 10, 2023 (CN) 202311304005.9

(51) Int. Cl. A44B 11/25; B29C 45/14; B29K 59/00; B29K 705/00; B29L 31/00

(52) U.S. Cl. CPC A44B 11/2534; A44B 11/2546; B29C 45/14065; B29C 2045/14122; B29K 2059/00; B29K 2705/00; B29K 2995/0008; B29L 2031/7274

(57) ABSTRACT

A buckle part includes: an injection-molded portion; and at least one magnetic body, optionally including a magnet secured in the injection-molded portion. The injection-molded portion is shaped such that the magnetic body is partially exposed in at least a first surface region of the magnetic body.

### CROSS-REFERENCE TO RELATED APPLICATIONS

The present application claims a priority to Chinese Patent Application No. CN 202311304005.9, filed on Oct. 10, 2023, the disclosures of which are expressly incorporated by reference herein in their entireties.

### BACKGROUND OF THE INVENTION

The present disclosure relates to a buckle part and a method of producing the same.

Japanese Registered Utility-model No. 3200327 discloses a buckle having a buckle body and a coupled member coupled thereto. The buckle body includes a magnet therein, and the coupled body includes a magnet therein, and the both can be magnetically attachable. In the buckle body, a pivot member is pivotably arranged on a base. The pivot member has an engaging portion at its facing end. The coupled member is provided with an engaged portion with which the engaging portion engages.

Japanese Utility-model application Laid-open No. 59-191912 discloses a buckle in which a female member is provided with a female coupling portion having a slope angled at about 45-85° and similarly, a male portion is provided with a male coupling portion having a slope angled at about 45-85°.

Japanese Examined Utility-model application Laid-open No. 7-31684 also discloses a buckle similar to the one disclosed in Japanese Utility-model application Laid-open No. 59-191912.

CN 206423650 U discloses a buckle having buckle body provided with a hole into which a magnet is inserted. Japanese patent application Laid-open No. 1-127303 discloses a technique where a magnet is used to position a magnetic piece in place at a mold.

### SUMMARY OF THE INVENTION

In a situation where a buckle part includes a magnetic body (e.g. magnet) therein, the magnetic body may preferably be arranged so as not to be visible from the outside of the buckle part. The present invention has been conceived by the present inventor in spite of such a custom.

Buckle part according to an aspect of the present disclosure may include: an injection-molded portion; and at least one magnetic body, optionally including a magnet, secured in the injection-molded portion. The injection-molded portion is shaped such that the magnetic body is partially exposed at least in a first surface region of the magnetic body. In an exemplary embodiment, the at least one magnetic body includes first and second external surfaces which are adjacently located, and the first surface region includes adjacent first and second partial surface regions and a first edge formed between the adjacent first and second partial surface regions, said first and second partial surface regions being included in said first and second external surfaces of the magnetic body respectively.

Method of producing a buckle part having at least one magnetic body according to another aspect of the present disclosure includes: disposing at least one magnetic body, optionally including a magnet, onto a plurality of support bosses provided in a first half cavity of a stationary mold; moving a movable mold toward the stationary mold to configure a molding cavity from the first half cavity of the stationary mold and a second half cavity of the movable mold; and supplying a molten resin into the molding cavity in a state where the magnetic body has been located inside the molding cavity. The plurality of support bosses includes a first support boss that is in contact with the magnetic body at least in an entire area of a first surface region of the magnetic body. In an exemplary embodiment, the first surface region includes first and second adjacent partial surface regions of adjacent first and second external surfaces of the magnetic body and a first edge formed between the first and second adjacent partial surface regions.

According to one aspect of the present disclosure, a magnetic body is insert-molded in a buckle part thereby being prevented from falling off and simultaneously owing to a shape of injection molded portion of the buckle part, simplification and/or a longer life span is promoted for a structure for positioning the magnetic body in place at a mold device for injection-molding.

### BRIEF DESCRIPTION OF DRAWINGS

FIG. 1 is a perspective view of a buckle according to one aspect of the present disclosure in which first and second buckle parts are in a coupled state;

FIG. 2 is a perspective view of a buckle according to one aspect of the present disclosure in which the first and second buckle parts are in a decoupled state. First and second magnets separated from the parts are depicted for reference;

FIG. 3 is a schematic top view of a buckle in which the first and second buckle parts are in a coupled state;

FIG. 4 is a schematic cross-sectional view taken along a center line of the buckle shown in FIG. 3;

FIG. 5 is a schematic cross-sectional view of the first buckle shown in FIG. 4;

FIG. 6 is a schematic cross-sectional view of the second buckle shown in FIG. 4;

FIG. 7 is a top view of the second buckle part;

FIG. 8 is a front view of the second buckle part;

FIG. 9 is a bottom view of the second buckle part;

FIG. 10 is a schematic partially enlarged perspective view of the second buckle part.

FIG. 11 is a schematic top view of the first buckle part, a female groove, a male portion and a bottom portion are depicted in a partial cross section.

FIG. 12 is a front view of the first buckle part.

FIG. 13 is a bottom view of the first buckle part.

FIG. 14 is a schematic partially enlarged perspective view of the first buckle part;

FIG. 15 is a schematic perspective view of the first buckle part;

FIG. 16 is a schematic illustration showing a process in which the first and second buckle parts are coupled;

FIG. 17 is a schematic illustration showing a process in which the first and second buckle parts are coupled;

FIG. 18 is a schematic illustration showing a process in which the first and second buckle parts are coupled;

FIG. 19 is a schematic illustration showing a state in which the first and second buckle parts have been fully coupled;

FIG. 20 is a schematic illustration showing a mold device for producing buckle parts;

FIG. 21 is a schematic illustration regarding arrangement of support boss and pusher boss for a second magnet in the mold device;

FIG. 22 is a schematic illustration regarding arrangement of support boss and pusher boss for a first magnet in the mold device.

### DETAILED DESCRIPTION OF THE INVENTION

Hereinafter, various embodiments and features would be discussed with reference to drawings. A skilled person would be able to combine respective embodiments and/or respective features without requiring excess description, and would appreciate synergistic effects of such combinations. Overlapping description among the embodiments would be basically omitted. Referenced drawings aim mainly for describing inventions and are simplified for the sake of convenience of preparation thereof. The respective features should be appreciated as universal features not only effective to buckle parts presently presented but also effective to other various buckle parts not presented in the present specification.

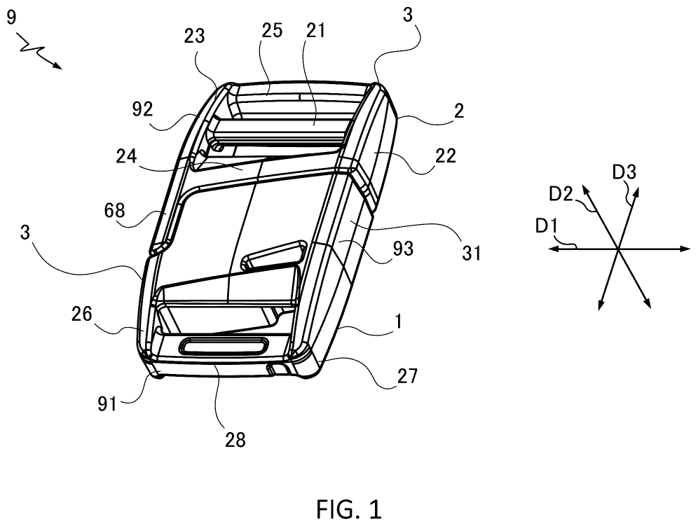

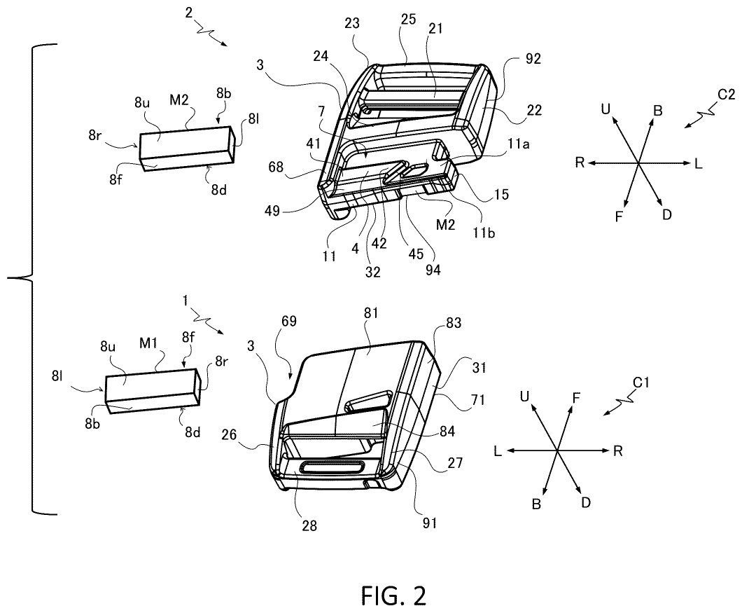

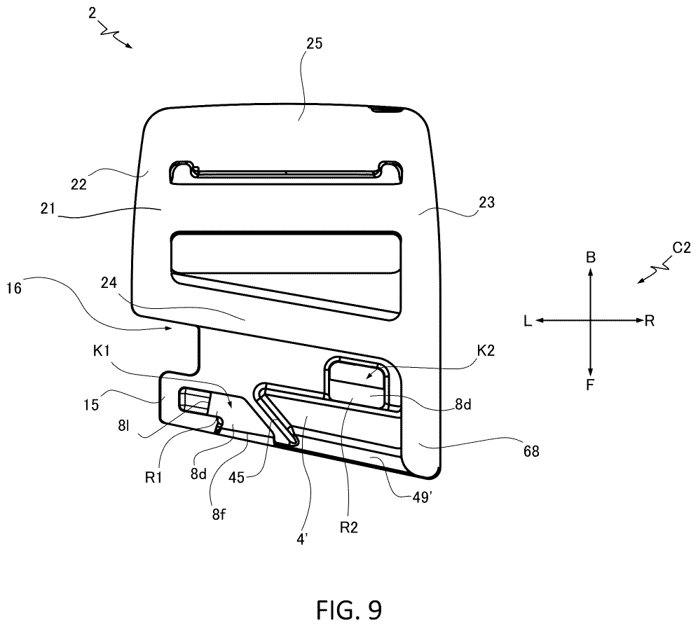

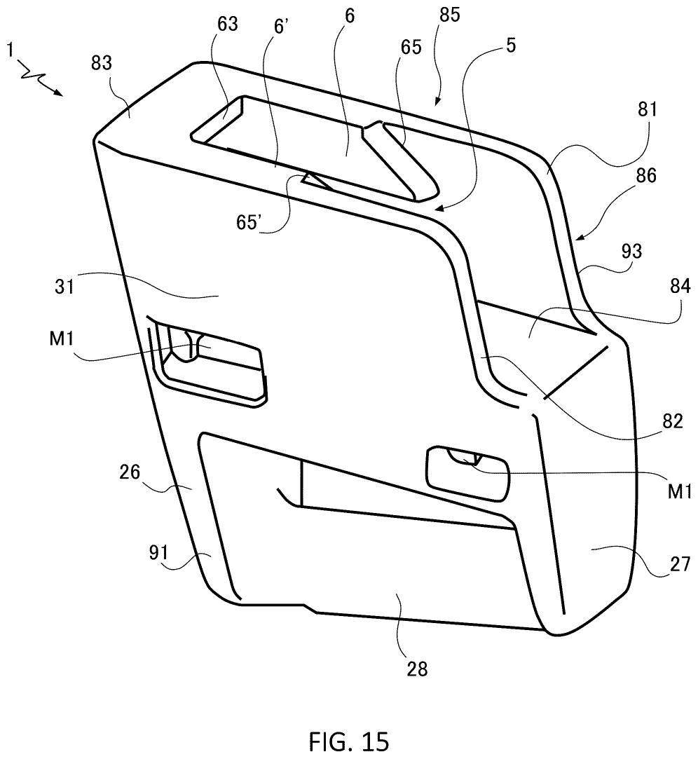

FIGS. 1 to 15 will be referred in the following description. For convenience of description, as illustrated in FIG. 1, three-dimensional coordinates of a width direction D1, a thickness direction D2, and a length direction D3 are set for a buckle 9. As illustrated in FIG. 2, a first coordinate C1 is set for a first buckle part 1 (hereinafter referred to as first part 1), and a second coordinate C2 is set for a second buckle part 2 (hereinafter referred to as second part 2). The C1 is set such that a facing direction of the first buckle part 1 toward the second buckle part 2 is a forward direction. A double-headed arrow between R and L indicates a left-right direction that matches a width direction of the first part 1. A double-headed arrow between F and B indicates a front-rear direction that matches a length direction of the first part 1. A double-headed arrow between U and D indicates an up-down direction that matches a thickness direction of the first part 1. The C2 is set such that a facing direction of the second part 2 toward the first part 1 is a forward direction. The double-headed arrow between R and L indicates a left-right direction that matches a width direction of the second part 2. The double-headed arrow between F and B indicates a front-rear direction that matches a length direction of the second part 2. The double-headed arrow between U and D indicates an up-down direction that matches a thickness direction of the second part 2. The width direction of the first part 1 and the width direction of the second part 2 are parallel to the width direction D1 of the buckle 9.

The buckle 9 includes first and second parts 1, 2 that are separably coupled. The first and second parts 1, 2 are configured to be magnetically coupled, and operation for coupling the first and second parts 1, 2 is automated or semi-automated. As illustrated in FIG. 1, the buckle 9 has a width direction D1, a thickness direction D2, and a length direction D3, and is typically a thin device having a width larger than a prescribed width of a webbing attached to the first and second parts 1, 2. Each of the first and second parts 1, 2 is an injection-molded resin product, and includes an injection-molded portion 3 and at least one magnet M1,M2 secured in the injection-molded portion 3. In short, the magnet M1,M2 is embedded in the injection-molded portion 3 through insert-molding, and thus the magnet M1,M2 is prevented from falling off the injection-molded portion 3. Furthermore owing to a shape of the injection-molded portion 3 described below, simplification and/or a longer life span is promoted for a positioning structure of mold device for producing the first and second parts 1, 2. Note that a resin material of the buckle part has magnetic permeability, and is polyacetal for example.

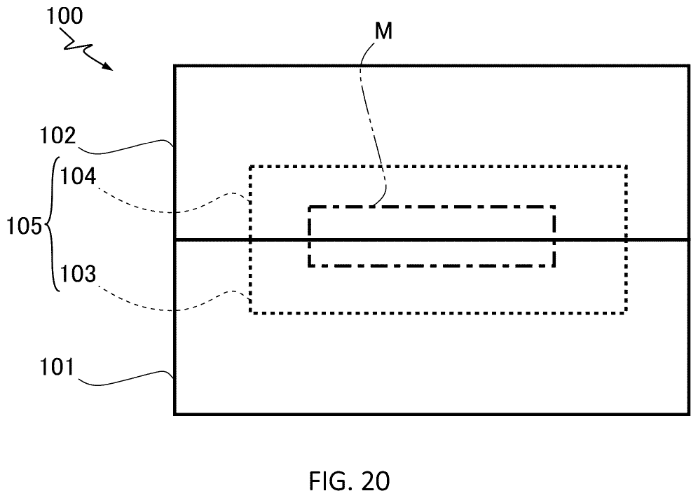

A mold device 100 schematically illustrated in FIG. 20 may be used for producing the first and second parts 1, 2. The mold device 100 includes a stationary mold 101 and a movable mold 102, and the movable mold 102 is movable up and down along a vertical direction relative to the stationary mold 101. Further, the stationary mold 101 has a first half cavity 103, the movable mold 102 has a second half cavity 104, and a molding cavity 105 is configured from the first and second half cavities 103 and 104 as the stationary mold 101 and the movable mold 102 are clamped. A molten resin is supplied into the molding cavity 105 while the magnet or the magnetic body M has been disposed in the molding cavity 105, and the resin is solidified by cooling the mold device 100 (e.g. by causing a refrigerant to flow through a refrigerant flow channel in the stationary mold 101 and/or the movable mold 102). The first and second parts 1, 2 may be produced through such a process. It may be preferable to employ a larger magnet in size in order to reduce influence of demagnetization of the magnet due to heat received during the injection molding but should not be limited to this example. Note that, commercially available devices such as an injection device, a mold clamping device and the like may be used as peripheral devices of the mold device 100, and a detailed description thereof will be omitted.

As illustrated in FIGS. 1 to 6, the first part 1 includes a first webbing attachment portion 91, a first engagement portion 93 connected to the first webbing attachment portion 91, and the first magnet M1. The second part 2 includes a second webbing attachment portion 92, a second engagement portion 94 connected to the second webbing attachment portion 92, and the second magnet M2. The first engagement portion 93 may include a housing 31, and the second engagement portion 94 may include an insertion portion 32 to be inserted into the housing 31. However, they should not be limited to such structures and may have other structures. The second part 2 may optionally include a stop wall 68, and the housing 31 of the first part 1 may be provided with a notch 69 for avoiding interference with the stop wall 68.

When the first and second parts 1, 2 are coupled (see FIG. 1), even if the second part 2 is pulled in a direction away from the first part 1 in the length direction D3 of the buckle 9, the coupling between the first and second parts 1, 2 is maintained. This is because male portion 4, 4′ of the second part 2 is inserted into female groove 5, 5′ of the first part 1. Additionally or alternatively, this is because male portion 6, 6′ of the first part 1 is inserted into female groove 7, 7′ of the second part 2. The same applies, mutatis mutandis, to a situation where the first part 1 is pulled in a direction away from the second part 2. The male portion 4, 4′, 6, 6′ may be a protruding portion in the thickness direction of the buckle part. The female groove 5, 5′, 7, 7′ may be a recess that receive the male portion 4, 4′, 6, 6′. One of the male portions on the upper and lower sides of the buckle part may be omitted, and the same applies to the female grooves.

The first and second parts 1, 2 are magnetically coupled in a direction different from the insertion direction of the male portion 4, 4′, 6, 6′ into the female groove 5, 5′, 7, 7′, i.e. magnetically coupled along the length direction D3 of the buckle 9. In one case, the first part 1 includes a first magnet M1 (e.g. a permanent magnet such as a neodymium magnet or the like) as a first magnetic body, and the second part 2 includes a second magnet M2 (e.g. a permanent magnet such as a neodymium magnet or the like) as a second magnetic body. When the first and second parts 1, 2 are located close to each other, the first and second parts 1, 2 approach each other according to the magnetic attraction force caused between the first and second magnets M1, M2, and are automatically coupled to each other as described hereinbelow. One or both of the first and second magnets M1, M2 may be a yoke-attached magnet.

As an alternative to the embodiment in which the first and second parts 1, 2 include respective magnets, an embodiment may be employed where one of the first and second parts 1, 2 includes a magnet (e.g. a neodymium magnet or the like) and the other includes a magnetic body (e.g. a ferromagnetic material such as iron, nickel, cobalt, or an alloy thereof) that may be magnetically attracted to the magnet. When the first and second parts 1, 2 are located close to each other, the magnetic body is magnetically attracted to the magnet, and a similar effect would be obtained. A plurality of magnets and/or magnetic bodies may be incorporated in the first part 1, and the same applies to the second part 2.

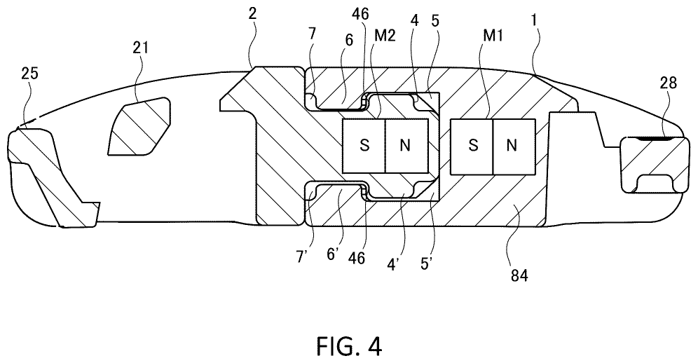

The first part 1 (e.g. the first engagement portion 93 thereof) has the female groove 5, 5′ extending along a width direction of the buckle part and the male portion 6, 6′ arranged adjacent to the female groove 5, 5′ on one side of the female grooves 5, 5′ which is a farther side from the first webbing attachment portion 91, i.e. arranged on the front side in the first part 1 (see FIG. 4). The second part 2 (or the second engagement portion 94) has the female groove 7, 7′ extending along the width direction of the buckle part and the male portion 4, 4′ arranged adjacent to the female groove 7, 7′ on one side of the female grooves 7, 7′ which is a farther side from the second webbing attachment portion 92, i.e. arranged on the front side in the second part 2 (see FIG. 4).

Preferably, the male portion 4, 4′, 6,6′ is an elongated protrusion extending along the width direction of the buckle part, e.g. extending in parallel or obliquely to the width direction, by which a coupling direction of the first and second parts 1, 2 is defined, facilitating proper operation of the buckle 9. The male portions 4 and 4′ protrude in the opposite directions along the up-down direction, and the same applies to the male portions 6 and 6′. The female groove 5, 5′, 7, 7′ is elongated along the width direction of the buckle part, e.g. in parallel or obliquely to the width direction. The female grooves 5 and 5′ are recessed in the opposite directions along the up-down direction, and the same applies to the female grooves 7 and 7′. In a case where the male portion and the female groove are inclined, easier removal of the male portion from the female groove may be suppressed.

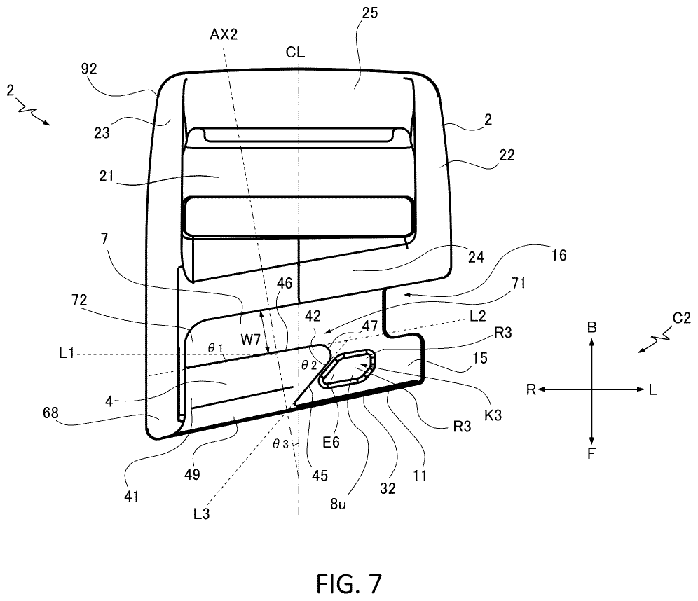

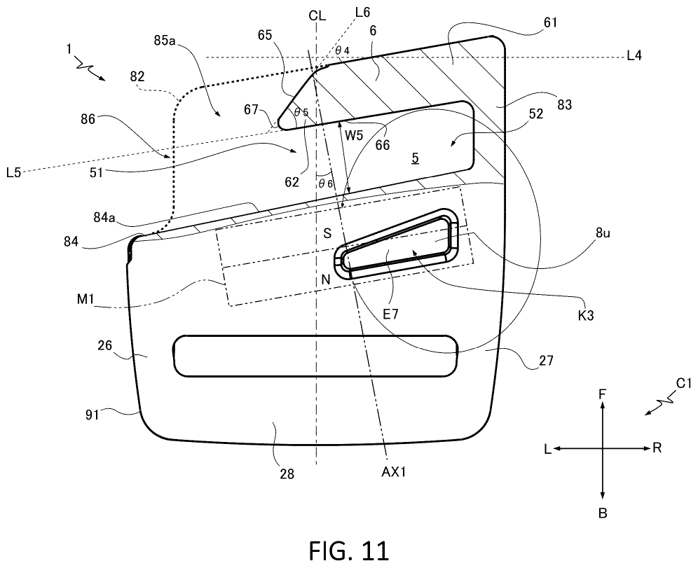

As illustrated in FIG. 7, the male portion 4, 4′ form an acute angle θ1 with an axial line L1 that matches the width direction of the second part 2. The same applies to the female groove 7, 7′. As illustrated in FIG. 11, the male portion 6, 6′ form an acute angle θ4 with an axial line L4 that matches the width direction of the first part 1. The same applies to the female groove 5, 5′. θ1=θ4 may be satisfied. θ1 and θ4 may be an acute angle of 45° or less, or 30° or less, or 25° or less, or 20° or less.

The male portion 4, 4′ may have a first end 41 and a second end 42, and may be inclined so as to approach the second webbing attachment portion 92 as extending from the first end 41 toward the second end 42, i.e. inclined to a rear side regarding the second part 2). The male portion 6, 6′ may have a first end 61 and a second end 62, and may be inclined so as to approach the first webbing attachment portion 91 as extending from the first end 61 toward the second end 62, i.e. inclined to a rear side regarding the first part 1.

The male portion 4, 4′ and the male portion 6, 6′ are provided complementarily in the width direction D1 of the buckle 9. That is, the male portion 6 is provided on the right side in the first part 1, and the male portion 4 is provided on the right side in the second part 2. Therefore, when the first and second parts 1, 2 face each other as depicted in FIG. 2, the male portion 4 and the male portion 6 do not face each other or only partially face each other in the length direction D3 of the buckle 9. Therefore, even if the first and second parts 1, 2 approach each other (e.g. in accordance with magnetic attraction force caused between the first and second magnets M1, M2), collision between the male portion 4 and the male portion 6 is suppressed. The same applies to the male portion 4′ and the male portion 6′.

The male portion 4, 4′ (preferably, the second end 42 thereof) has a guide surface 45 extending along an axial line L3 forming an acute angle θ2 with an axial line L2 parallel to a longitudinal direction of the male portion 4, 4′, a stopper surface 46 located rearward of the guide surface 45 and extending along the axial line L2, and a rounded edge 47 formed between the guide surface 45 and the stopper surface 46 (see FIG. 7). Note that the axial line L2 matches the insertion direction of the male portion 4, 4′ into the female groove 5, 5′. The guide surface 45 is a side surface of the male portion 4, 4′ (i.e. a side surface of the second end 42), and the stopper surface 46 is a rear surface of the male portion 4, 4′.

The male portion 6, 6′ (preferably, the second end 62 thereof) has a guide surface 65 extending along an axial line L6 forming an acute angle θ5 with an axial line L5 parallel to the longitudinal direction of the male portion 6, 6′, a stopper surface 66 located rearward of the guide surface 65 and extending along the axial line L5, and a rounded edge 67 formed between the guide surface 65 and the stopper surface 66 (see FIG. 11). Note that the axial line L5 matches the insertion direction of the male portion 6, 6′ into the female groove 7, 7′. The guide surface 65 is a side surface of the male portion 6 or 6′ (i.e. a side surface of the second end 62), and the stopper surface 66 is a rear surface of the male portion 6, 6′.

The guide surfaces 45, 65 are arranged at the male portions 4, 4′, 6, 6′ as described above so that each of the male portion 4, 4′ and the male portion 6, 6′ may move away from the other one, ensuring smoother and easier initial engagement of the first and second buckle parts 1, 2. Preferably, θ2, θ5 is equal to an angle in the range of 25° to 75° or in the range of 35° to 65°.

The female groove 5, 5′ has an introduction end 51 and an opposite end 52 opposite to the introduction end 51. The female groove 5, 5′ extends obliquely between the introduction end 51 and the opposite end 52 and in more detail, is inclined away from a rear end of the first webbing attachment portion 91 as being away from the introduction end 51 toward the opposite end 52 (i.e. inclined to a front side regarding the first part 1). The introduction end 51 is an entrance for the male portion 4, 4′ to be inserted into the female groove 5, 5′ and an exit of the male portion 4, 4′ to be drawn out of the female groove 5, 5′. The second end 62 of the male portion 6, 6′ is located adjacent to and in front of the introduction end 51. It is not a requisite for the male portion 4, 4′ to be inserted into the female groove 5, 5′ to an extent that the second end 42 of the male portion 4, 4′ reaches the opposite end 52 of the female groove 5, 5′. The opposite end 52 may be a closed end closed by a side plate 83, but should not be limited thereto. In the illustrated example, the female groove 5, 5′ has a width W5 defined by the stopper surface 66 (a rear surfaces) of the male portion 6, 6′ and a bottom surface 84a of a bottom portion 84 described below. A bottom surface of the female groove 5 matches a lower surface of an upper plate 81 described hereinbelow, and a bottom surface of the female groove 5′ matches an upper surface of a lower plate 82 described hereinbelow.

The female groove 7, 7′ has an introduction end 71 and an opposite end 72 opposite to the introduction end 71. The female groove 7, 7′ extends obliquely between the introduction end 71 and the opposite end 72 and in more detail, is inclined away from a rear end of the second webbing attachment portion 92 as being away from the introduction end 71 toward the opposite end 72 (i.e. inclined to a front side regarding the first part 1). The introduction end 71 is an entrance for the male portion 6, 6′ to be inserted into the female groove 7, 7′ and an exit of the male portion 6, 6′ to be drawn out of the female groove 7, 7′. The second end 42 of the male portion 4, 4′ is located adjacent to and in front of the introduction end 71. Again, it is not a requisite for the male portion 6, 6′ to be inserted into the female groove 7, 7′ to an extent that the second end 62 of the male portion 6, 6′ reaches the opposite end 72 of the female groove 7, 7′. The opposite end 72 may be a closed end closed by the stop wall 68, but should not be limited thereto.

The first webbing attachment portion 91 is configured to contour at least one opening through which the webbing is inserted, and includes left and right walls 26, 27 and a bar 28. The bar 28 extends in the width direction of the first part 1 and connects the rear ends of the left and right walls 26, 27. The second webbing attachment portion 92 is configured allow adjustment of the length of the webbing. Typically, the second webbing attachment portion 92 includes a frame that supports one or more bars 21 extending in parallel in the width direction of the second part 2, and includes left and right walls 22 and 23 and front and rear walls 24 and 25 in addition to the bar 21. The bar 21 is supported by the left and right walls 22 and 23, and a space between the front wall 24 and the rear wall 25 is sectioned by the bar 21. Respective cross-sectional shapes of the front wall 24, the bar 21, and the rear wall 25 are optimized for attachment of the webbing.

The housing 31 has the upper and lower plates 81, 82, the side plate 83, and the bottom portion 84, and by which a housing space is defined which is open on the front side and one of the left and right sides (on the left side in the illustrated case). The upper plate 81 (e.g. a front end thereof) is provided with the (upper) male portion 6 protruding toward the lower plate 82, and the (upper) female groove 5 is defined between the male portion 6 and the bottom portion 84. The lower plate 82 (e.g. a front end thereof) is provided with the (lower) male portion 6′ protruding toward the upper plate 81, and the (lower) female groove 5′ is defined between the male portion 6′ and the bottom portion 84. The female groove 5 and the female groove 5′ are shaped in mirror symmetry, but should not be limited to this.

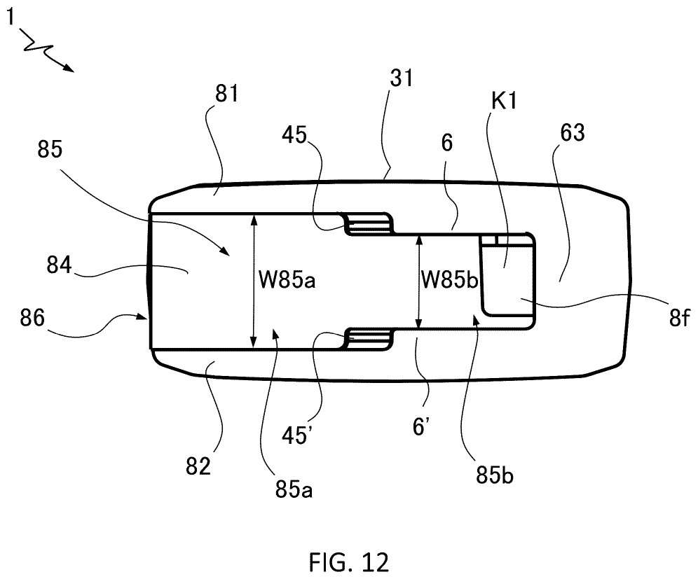

The housing space of the housing 31 is open in two directions of the front side and one of the left and right sides, thereby promoting smoother coupling of the first and second parts 1, 2. A front mouth 85 of the housing 31 is wide in the width direction of the buckle part, is defined by the upper and lower plates 81 and 82 and the side plate 83, has an open end on one of the left and right sides (on the left side in the illustrated case), and has a closed end on the other of the left and right sides (on the right side in the illustrated case). The front mouth 85 of the housing 31 includes an opening section 85a having a width W85a in the up-down direction between the upper plate 81 and the lower plate 82, and an opening section 85b having a width W85b in the up-down direction reduced by the male portions 6, 6′ (see FIG. 12). The opening section 85a also spatially communicates with a side opening 86. The opening section 85b may be formed between a closure wall 63 and the opening section 85a described above.

The side opening 86 of the housing 31 is an opening on one side of the housing space in the width direction of the buckle part, is defined by the upper and lower plates 81 and 82 and the bottom portion 84, and has an open end on the front side and has a closed end on the rear side. Note that there is an advantage in that the housing space of the housing 31 is open only on one of the left and right sides and is not open on both the left and right sides. A direction or manner of insertion of the insertion portion 32 into the housing 31 may be restricted for example, thus preventing the insertion portion 32 from being inserted into the housing 31 in an unintended direction or manner.

The bottom portion 84 may have the bottom surface 84a which is inclined parallel to the male portions 6, 6′. Typically, the stopper surface 66 of the male portion 6, 6′ and the bottom surface 84a of the bottom portion 84 face each other to define the width W5 of the female groove 5, 5′. The bottom surface 84a of the bottom portion 84 is not necessarily a flat surface. The width W5 of the female groove 5, 5′ is not necessarily constant in the width direction of the first part 1 and may fluctuate.

A thickness of the bottom portion 84 in the up-down direction is greater than a thickness of the first magnet M1 in the up-down direction and, for example, is 1.2 times or more, 1.3 times or more, 1.4 times or more, or 1.5 times or more of the thickness of the first magnet M1 in the up-down direction, not necessarily limited to this though. A distance between the bottom surface 84a of the bottom portion 84 and a front surface of the first magnet M1 embedded in the bottom portion 84 is preferably thin, and is less than ⅕ of the width of the first magnet M1 in the front-rear direction, for example.

The insertion portion 32 is connected to the second webbing attachment portion 92 (e.g. its front wall 24), and is optionally also connected to the stop wall 68. The insertion portion 32 includes a plate-shaped portion 11 having an upper surface 11a and a lower surface 11b, the male portion 4 provided on the upper surface 11a, and the male portion 4′ provided on the lower surface 11b. The male portions 4 and 4′ are shaped in mirror symmetry in the up-down direction, but should not be limited to this. The insertion portion 32 may have a chamfer 49 interposed between an upper surface of the male portion 4 and a front surface of the plate-shaped portion 11 (see FIG. 2), and may additionally or alternatively have a chamfer 49′ interposed between a lower surface of the male portion 4′ and a front surface of the plate-shaped portion 11. Thus, insertion of the insertion portion 32 into the housing 31 is facilitated. A front surface of the male portion 4 is partially included in the chamfer.

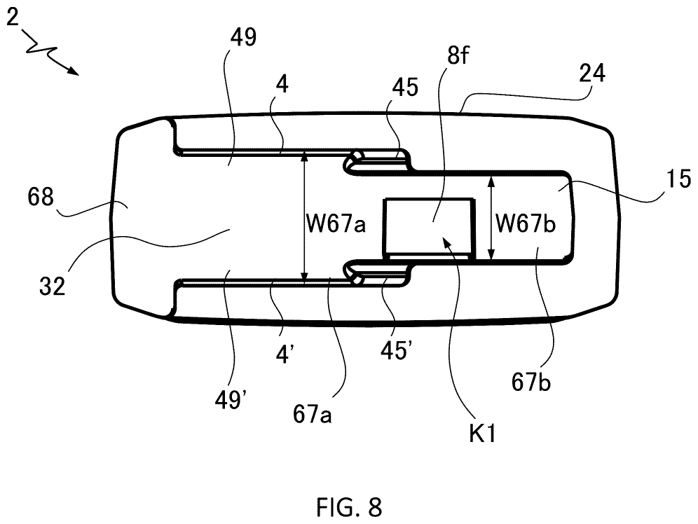

The insertion portion 32 has a thick portion 67a having a greater thickness W67a and a thin portion 67b having a lesser thickness W67b (see FIG. 8). The thick portion 67a consists of the male portions 4 and 4′ and a portion of the plate-shaped portion 11 to which the male portions 4 and 4′ are connected. The thin portion 67b consists of a portion of the plate-shaped portion 11 where the male portions 4 and 4′ are not provided. The thickness of the thin portion 67b is greater than a thickness of the second magnet M2 in the up-down direction, thereby allowing the second magnet M2 to be more firmly secured in the plate-shaped portion 11. A distance between the front surface of the insertion portion 32 and a front surface of the second magnet M2 is preferably thin, and is less than ⅕ of a width of the second magnet M2 in the front-rear direction, for example.

It is possible for the thick and thin portions 67a and 67b to be inserted into the opening section 85a of the front mouth 85 of the housing 31. The thin portion 67b may be inserted into the opening section 85b of the front mouth 85 of the housing 31, but the thick portion 67a may not be inserted thereto. Note that the thick and thin portions 67a and 67b may also be inserted into the side opening 86 of the housing 31 described hereinbelow.

The plate-shaped portion 11 may be formed longer than the male portion 4, 4′ in the width direction of the second part 2. This allows the thin portion 67b to have a sufficient width in the width direction of the second part 2, ensuring smoother and easier initial engagement between the first and second parts 1, 2. The plate-shaped portion 11 (and/or the thin portion 67b) has a projection 15 projecting on the same axial line as the male portion 4, 4′ in the width direction of the second part 2, and a gap 16 is formed between the projection 15 and the second webbing attachment portion 92 (see FIG. 7). On the other hand, the housing 31 has the closure wall 63 that partially closes the front mouth 85 of the housing 31 (see FIGS. 8 and 11). As the male portion 4, 4′, 6, 6′ is fully inserted into the female groove 5, 5′, 7, 7′, the closure wall 63 is plugged into the aforementioned gap 16, thus strengthening the coupling of the first and second parts 1, 2.

The female groove 7, 7′ is formed between the male portion 4, 4′ and the second webbing attachment portion 92. The female groove 7, 7′ has a width W7 defined by the stopper surface 46 (rear surface) of the male portion 4, 4′ and a front surface of the front wall 24. A bottom surface of the female groove 7 matches an upper surface of the plate-shaped portion 11, and a bottom surface of the female groove 7′ matches a lower surface of the plate-shaped portion 11. Depth of the female groove 7 matches a height of the upper surface of the male portion 4 relative to the upper surface 11a of the plate-shaped portion 11, and depth of the female groove 7′ matches a height of the lower surface of the male portion 4′ relative to the lower surface 11b of the plate-shaped portion 11.

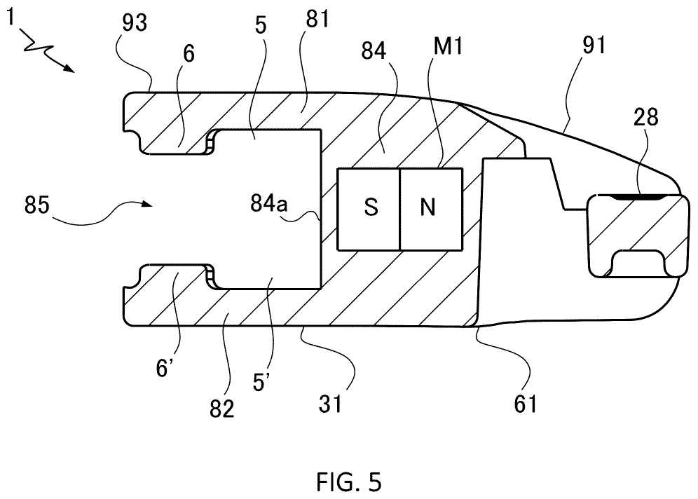

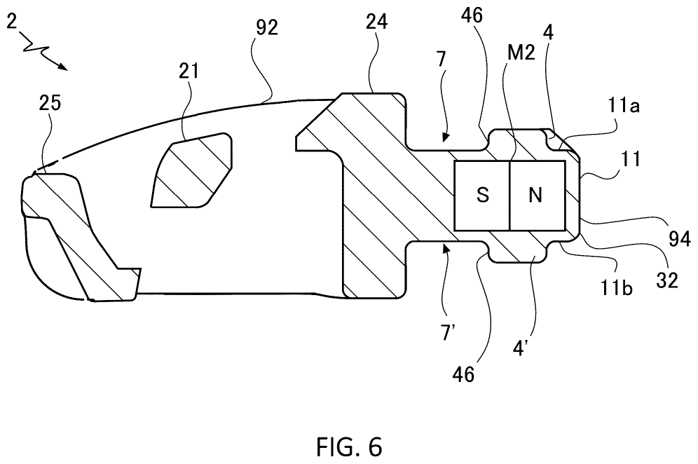

The first magnet M1 is embedded and secured in the bottom portion 84 of the housing 31 (see FIG. 5). The first magnet M1 is positioned at an intermediate height between the upper and lower plates 81 and 82 and at an intermediate height between the male portions 6 and 6′. The first magnet M1 is located behind the male portion 6, 6′ and the female groove 5, 5′. The second magnet M2 is embedded and secured in the insertion portion 32 (e.g. the plate-shaped portion 11) (see FIG. 6). The second magnet M2 is located between the male portions 4 and 4′ and is sandwiched therebetween in the up-down direction. The second magnet M2 is located closer to the front than the female grooves 7, 7′. As the first and second parts 1, 2 are fully coupled, the first magnet M1 and the second magnet M2 are at the closest positions and are disposed on the same plane as illustrated in FIG. 4. Further, the second magnet M2 is housed in the housing 31 entirely.

The first and second magnets M1, M2 may have three or more external surfaces. Typically, the first and second magnets M1, M2 are polyhedrons having four or more surfaces, and most preferably are cubes or rectangular solids. As illustrated in FIG. 2, the first and second magnets M1, M2 each is a rectangular solid having 6 external surfaces of upper, lower, front, rear, left and right surfaces 8u, 8d, 8f, 8b, 81, and 8r. The front, rear, left and right surfaces 8f, 8b, 81, and 8r extend along the thickness direction D2 of the buckle 9 (and the thickness direction of the buckle part). The upper and lower surfaces 8u and 8d are orthogonal to or intersect with the thickness direction D2 of the buckle 9 (and the thickness direction of the buckle part). Note that the front and rear surfaces 8f and 8b are orthogonal to or intersecting with the length direction D3 of the buckle 9. The left and right surfaces 81 and 8r are orthogonal to or intersecting the width direction D1 of the buckle 9 and/or elongation direction of the magnet. Advantageously, the first magnet M1 is elongated along the width direction D1 of the buckle 91 e.g. so as to be a rectangular solid, and is not displaceable along its elongation direction as being embedded in the injection-molded portion 3. The second magnet M2 is elongated along the width direction D1 of the buckle 91 e.g. so as to be a rectangular solid, and is not displaceable along its elongation direction as being embedded in the injection-molded portion 3. The first and second magnets M1,M2 are oriented along, e.g. in parallel to, the male portion 4, 4′, the male portion 6, 6′, the female groove 5, 5′ and/or the female groove 7, 7′, for example. The left surface 81 is partially covered by the injection-molded portion 3 and the right surface 8r is entirely covered by the injection-molded portion 3 in the second part 2.

The mold device 100 is provided with a positioning structure for positioning the first magnet M1. A plurality of windows is formed in the injection-molded portion 3 corresponding to the positioning structure of the mold, and the first magnet M1 is partially exposed. The same applies to the second magnet M2.

As illustrated in FIG. 7, the second engagement portion 94 (the insertion portion 32 or the plate-shaped portion 11) has a third window K3 formed on the upper side thereof. As illustrated in FIGS. 8 to 10, the second engagement portion 94 (the insertion portion 32 or the plate-shaped portion 11) has first and second windows K1 and K2 formed on the lower side thereof, and thus the first magnet M1 is exposed at a plurality of different surface regions thereof. As the first and second windows K1 and K2 are formed on the lower side of the second engagement portion 94, these windows are more difficult to be seen from the outside under the normal use of the buckle 9. Additionally or alternatively, the first and second windows K1, K2 do not penetrate through the male portion 4′, thus ensuring the mechanical strength of the male portion 4′.

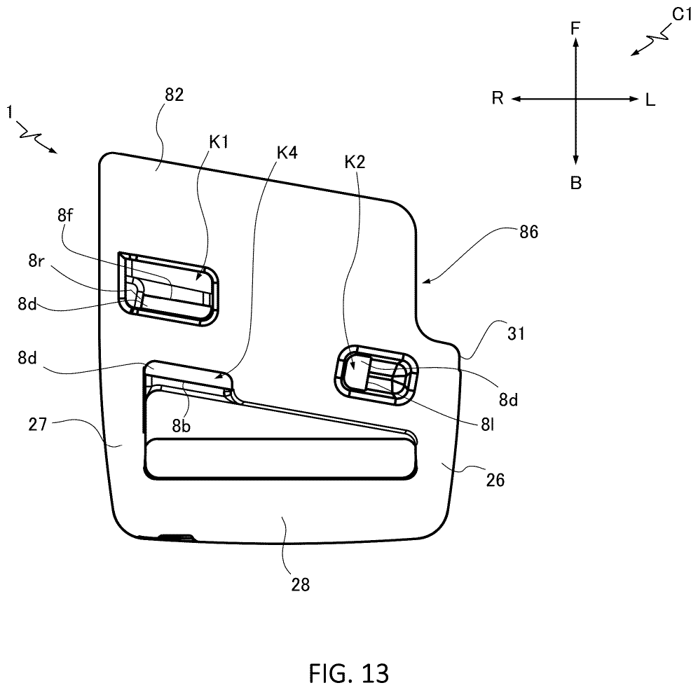

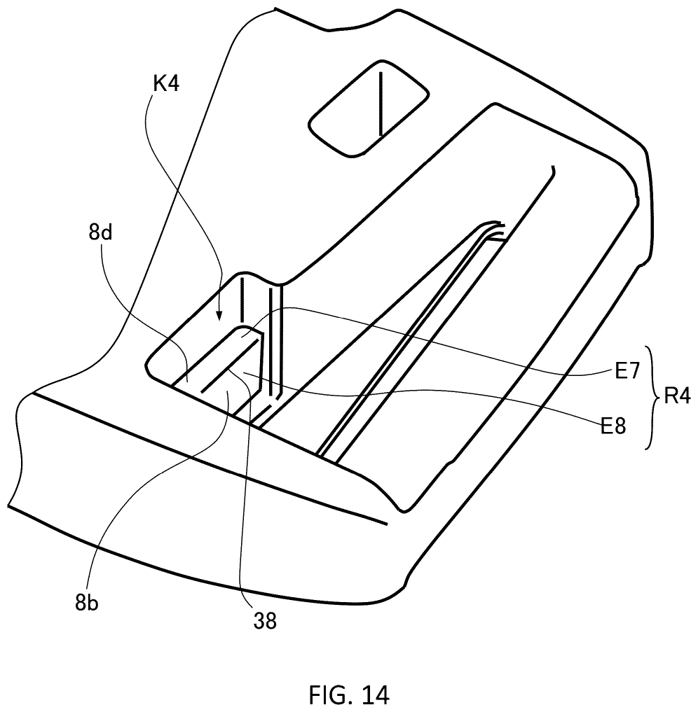

As illustrated in FIG. 11, the first engagement portion 93 (housing 31) has a third window K3 formed on the upper side thereof. As illustrated in FIGS. 13 and 14, the second engagement portion 94 (plate-shaped portion 11) has first and second windows K1 and K2 and further a fourth window K4 formed on the lower side thereof, and thus the second magnet M2 is exposed at a plurality of different surface regions thereof. As described above, as the windows K1, K2, and K4 are formed on the lower side of the first engagement portion 93, these windows are more difficult to be seen from the outside under the normal use of the buckle 9. Unlike the third window K3, the first, second and fourth windows K1, K2, and K4 are formed so as to expose not only one external surface of the first and second magnets M1, M2 but to expose plural external surfaces thereof.

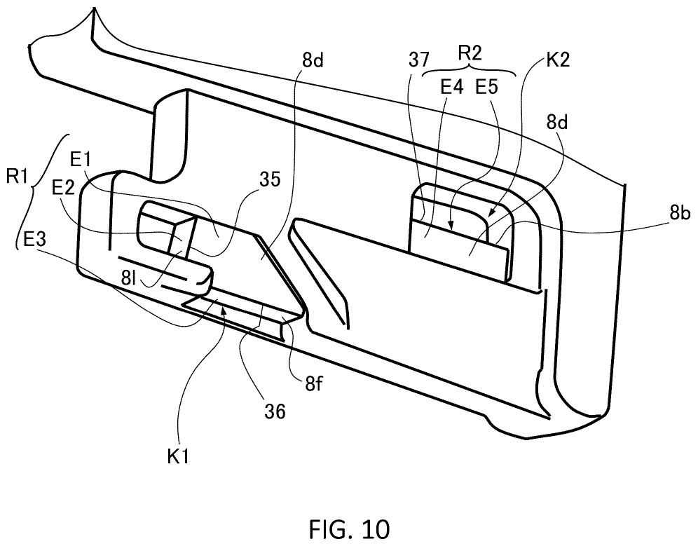

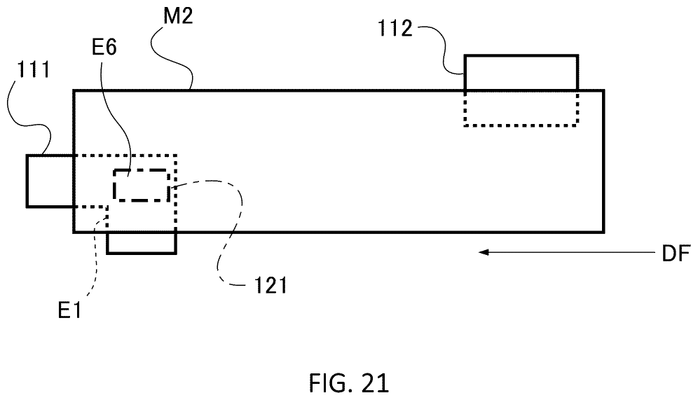

More detail description follows with reference to FIG. 10. The second magnet M2 has a first surface region R1 exposed in the first window K1. The first surface region R1 in the first window K1 includes an exposed first partial surface region E1 of the lower surface 8d of the M2, an exposed second partial surface region E2 of the left surface 81 of the M2, and further an exposed third partial surface region E3 of the front surface 8f of the M2. In addition, a first edge 35 formed between the first and second partial surface regions E1 and E2 is also exposed, and similarly a second edge 36 formed between the second and third partial surface regions E2 and E3 is also exposed. This means that a first support boss 111 (see FIG. 21) of the mold is in contact with the three surfaces of the M2, and the positioning structure of the mold may be simplified and the life may be extended. The support bosses are less likely to be damaged by unintended contact or the like due to an increase in size of the support bosses. Note that a resin portion of the second engagement portion 94 (plate-shaped portion 11) covers a corner formed by the lower, left and front surfaces 8d, 8l, 8f of the M2, allowing the injection-molded portion 3 to maintain sufficient holding force to hold the M2.

As illustrated in FIG. 10, the second magnet M2 has a second surface region R2 exposed in the second window K2. The second surface region R2 in the second window K2 includes an exposed fourth partial surface region E4 on the lower surface 8d of the M2, and an exposed fifth partial surface region E5 on the rear surface 8b of the M2. In addition, a third edge 37 formed between the fourth and fifth partial surface regions E4 and E5 is also exposed. This means that a second support boss 112 (see FIG. 21) of the mold is in contact with the two external surfaces of the M2 as described above, and the positioning structure of the mold may be simplified and the life thereof may be extended. Note that the resin portion of the second engagement portion 94 (plate-shaped portion 11) covers the corner formed by the lower, rear and right surfaces 8d, 8b, 8r of the M2, allowing the injection-molded portion 3 to maintain sufficient holding force to hold the M2.

As illustrated in FIG. 7, the second magnet M2 has a third surface region R3 exposed in the third window K3. The third surface region R3 in the third window K3 includes an exposed sixth partial surface region E6 on the upper surface 8u of the M2. This means that a pusher boss 121 (see FIG. 21) of the mold is in contact with one external surface of the M2. In particular, at least a part of the third surface region R3 may be located on the opposite side of the first surface region R1. The M2 is sandwiched between the first support boss 111 and the pusher boss 121 from above and below, and thus the displacement thereof is prevented despite a pressure received from a molten resin in the molding cavity 105. The M2 may be provided with a recess to be fitted (separably) to the support boss or the pusher boss.

The description on the windows K1 to K3 of the second part 2 similarly applies to the windows K1 to K3 of the first part 1 illustrated in FIGS. 11 to 13, and redundant description will be omitted. Note that, unlike the window K1 of the second part 2, the window K1 of the first part 1 partially exposes the first magnet M1 in two external surfaces not in three faces. Unlike the second part 2, the first part 1 further has the fourth window K4.

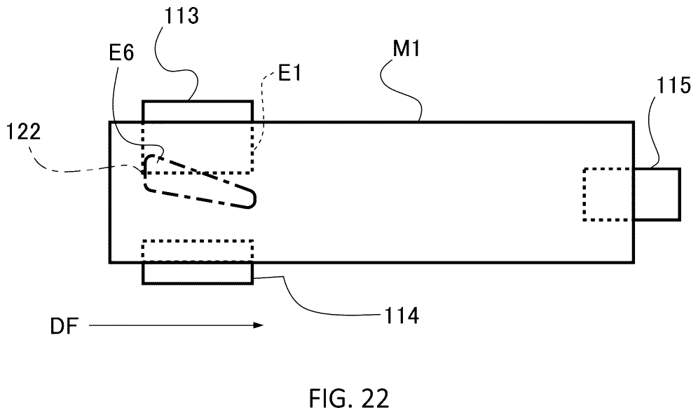

As illustrated in FIG. 14, a fourth surface region R4 in the fourth window K4 of the housing 31 includes an exposed seventh partial surface region E7 of the lower surface 8d of the first magnet M1 and an exposed eighth partial surface region E8 of the rear surface 8b of the first magnet M1. In addition, an edge 38 formed between the seventh and eighth partial surface regions E7 and E8 is also exposed. This means that a fourth support boss 114 (see FIG. 22) of the mold is in contact with the two external surfaces of the M1, and the positioning structure of the mold may be simplified and the life thereof may be extended. Note that the resin of the housing 31 covers a corner formed by the lower, rear and right surfaces 8d, 8b, 8r of the M1, allowing the injection-molded portion 3 to maintain sufficient holding force to hold the M1.

Likewise the description on the first part 1, at least a part of the third surface region R3 may be located on the opposite side of the first surface region R1 in the second part 2. The first magnet M1 is sandwiched between a third support boss 113 and a pusher boss 122 from above and below, and thus the displacement thereof is prevented despite the pressure received from the molten resin in the molding cavity 105.

As can be seen from the above description, in the respective first and second parts 1, 2, the injection-molded portion 3 is shaped such that the magnet M1, M2 is partially exposed at least in the first surface region R1 of the magnet M1, M2. Exemplarily, the first surface region R1 includes the adjacent first and second partial surface regions E1, E2 of the adjacent first and second external surfaces of the magnet M1, M2 and the first edge 35 formed between the adjacent first and second partial surface regions E1, E2. In this way, simultaneously as the magnet being prevented from falling off the buckle part, it is facilitated that the positioning structure of the mold device for positioning the magnet or the magnetic body is simplified or a life span thereof is extended.

Advantageously, at least one magnet M1, M2 is a hexahedron, and the injection-molded portion 3 is shaped such that five external surfaces except one external surface of the six external surfaces of the hexahedron are partially exposed. This means that a support boss corresponding to said one external surface is not provided. However, even in this case, the molten resin may be supplied to cause a molten resin flow in the molding cavity 105 so as to push the one external surface, thereby the magnet may be suppressed from being displaced. In FIGS. 21 and 22, the flow direction of the molten resin in the molding cavity 105 is schematically indicated by an arrow DF. From the viewpoint of not only reducing the influence of demagnetization due to the thermal influence but also reducing the displacement due to the molten resin flow, it is preferable to employ the magnet M1, M2 having a larger size. In some cases, the magnet M1, M2 has a width exceeding ½ of the maximum width of the buckle part in the width direction of the buckle part. Note that, when the magnet or the magnetic body is a polyhedron, it is possible to more firmly secure the magnet or the magnetic body by covering all corners of the polyhedron with the injection-molded portion 3.

The injection-molded portion 3 may have a plurality of windows K1 to K3 or windows K1 to K4 as described above. By increasing the number of windows, the magnet or the magnetic body may be positioned and secured more stably in the molding cavity 105, but the positioning structure of the mold device 100 becomes complicated, and each boss becomes smaller with increased risk of damage. For example, if six bosses were provided corresponding to the six external surfaces of the magnet M1, M2, the structure of the mold device 100 becomes complicated, and the size of each boss becomes smaller. In the present embodiment, the above-described shape of the injection-molded portion 3 may promote simplification and a longer life span of the positioning structure of the mold device 100.

As can be seen from the above description, the second window K2 is at a different location from the first window K1 and recessed in the same direction as a direction the first window K1 is recessed in the thickness direction of the buckle part 1, 2 so as to partially expose at least one magnet M1, M2. The third window K3 is recessed in a direction opposite to a direction the first window K1 is recessed in the thickness direction of the parts 1 and 2 to partially expose the at least one magnet M1, M2. The third surface region R3 may include the partial surface region E6 located on the opposite side of one of the first and second partial surface regions E1, E2.

Advantageously, the first and second windows K1 and K2 are positioned adjacent to the both ends of the magnet or magnetic body having a rectangular solid. Additionally or alternatively, one of the left and right surfaces of the rectangular solid magnet or magnetic body is selectively covered by the injection-molded portion 3 over its entire area. This makes it possible to more firmly hold the magnet or the magnetic body.

It is envisioned that the orientation of the first and second magnets M1, M2 in the injection-molded portion 3 may be various, but exemplary ones are as follows. The first magnet M1 is oriented along (e.g. parallel to or substantially parallel to) the female groove 5, 5′, and the second magnet M2 is oriented along (e.g. parallel to or substantially parallel to) the male portion 4, 4′. The first magnet M1 may be oriented such that its magnetic axis AX1 is orthogonal to or intersects with the extending direction of the female groove 5, 5′ (an axial line L5 that is parallel to the insertion direction of the male portion 4, 4′ into the female groove 5, 5′). The second magnet M2 may be oriented such that its magnetic axis AX2 is orthogonal to or intersects with the extending direction of the male portion 4, 4′ (an axial line L2 that is parallel to the insertion direction of the male portion 4, 4′ into the female groove 5, 5′). Thus, the male portion 4, 4′, 6, 6′ would be smoothly inserted into the female groove 5, 5′, 7, 7′ in accordance with the magnetic attraction force (in particular, the magnetic attraction force in the radial direction with respect to the magnetic axes AX1 and AX2) caused between the first and second magnets M1, M2. The magnetic axis AX1 may cross the axial line L5 at an acute angle of 60° or more. The magnetic axis AX2 may cross the axial line L2 at an acute angle of 60° or more.

The magnetic axis AX1 of the first magnet M1 forms an acute angle θ6 with respect to a center line CL of the first part 1, corresponding to the acute angle θ4 (see FIG. 11) related to the inclination of the female groove 5 (see FIG. 11). The magnetic axis AX2 of the second magnet M2 forms an acute angle θ3 with respect to the center line CL of the buckle 9 (see FIG. 7), corresponding to the acute angle θ1 related to the inclination of the male portion 4, 4′(see FIG. 7). The acute angle θ1, θ3, θ4, θ6 are the same or substantially the same. The acute angles θ3, θ4 are the same as or substantially the same as the acute angles θ1, θ2.

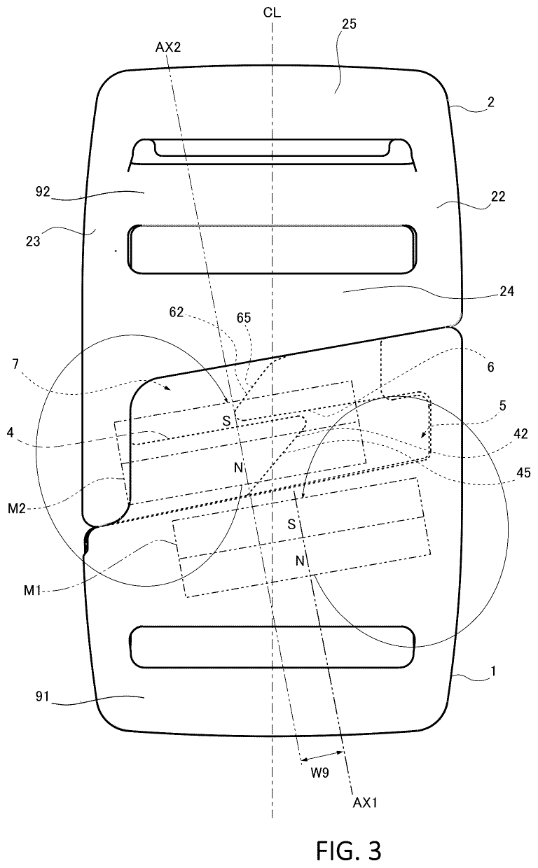

Note that the magnetic axis of the magnet matches a central axis for a multiplicity of magnetic lines directed from the N pole to the S pole of the magnet (see FIG. 3). In other words, the magnetic axis of the magnet is located at the center of the magnet in the width direction of the buckle part, and matches the axis on which the different magnetic poles are arranged. The arrangement of the magnetic poles of the first and second magnets M1, M2 is as illustrated in FIG. 3.

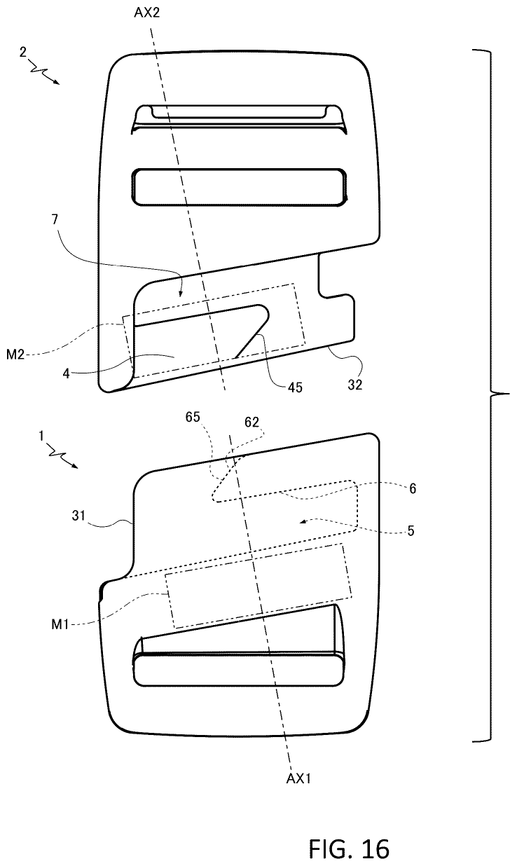

A process of coupling the first and second parts 1, 2 will be discussed with reference to FIGS. 16 to 19. At a state illustrated in FIG. 16, a magnetic attraction force is caused between the first and second magnets M1, M2, and thus the first and second parts 1, 2 move so as to approach each other. Note that, in the following description, it is assumed that the second part 2 is fixed at a predetermined position, and the first part 1 approaches the second part 2, but the opposite case and the case where the both approach one another would be similarly understandable.

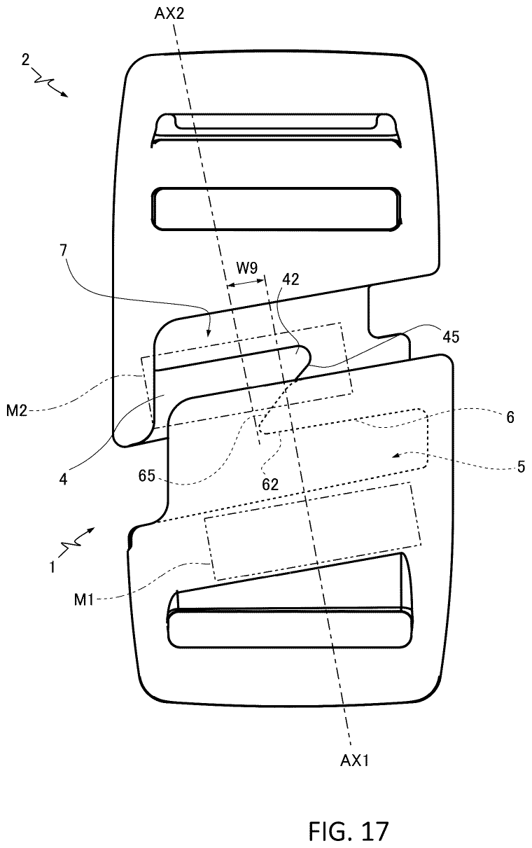

In a state illustrated in FIG. 17, the second end 62 (the guide surface 65 in the illustrated example) of the male portion 6, 6′ slides on the guide surface 45 of the male portion 4, 4′ in accordance with the magnetic attraction force caused between the first and second magnets M1, M2. Likewise, the second end 42 of the male portion 4, 4′ also slides on the guide surface 65 of the male portion 6, 6′. In the illustrated example, the guide surface 45 of the male portion 4, 4′ and the guide surface 65 of the male portion 6, 6′ contact each other to ensure a smooth displacement between the male portion 4, 4′ and the male portion 6, 6′. As the second end 62 of the male portion 6,6′ slides on the guide surface 45 of the male portion 4, 4′, the first magnet M1 approaches the second magnet M2 but in contrast, an interval W9 between the magnetic axis AX1 and the magnetic axis AX2 increases. By way of precaution, the second end 62 of the male portion 6, 6′ functions as a sliding portion. The end of the male portion sliding on the guide surface may be referred to as a sliding portion.

While shifting from the state of FIG. 16 to the state of FIG. 17, the male portion 4, 4′ of the second part 2 and the male portion 6, 6′ of the first part 1 may collide with each other, preventing the insertion portion 32 from being inserted into the housing 31 (in turn, automatic coupling of the first and second parts 1, 2 be potentially prevented). However, even if it happened, it would be possible to escape from this state to the state illustrated in FIG. 13 without difficulty in most cases by applying a slight external force to one of the first and second parts 1, 2.

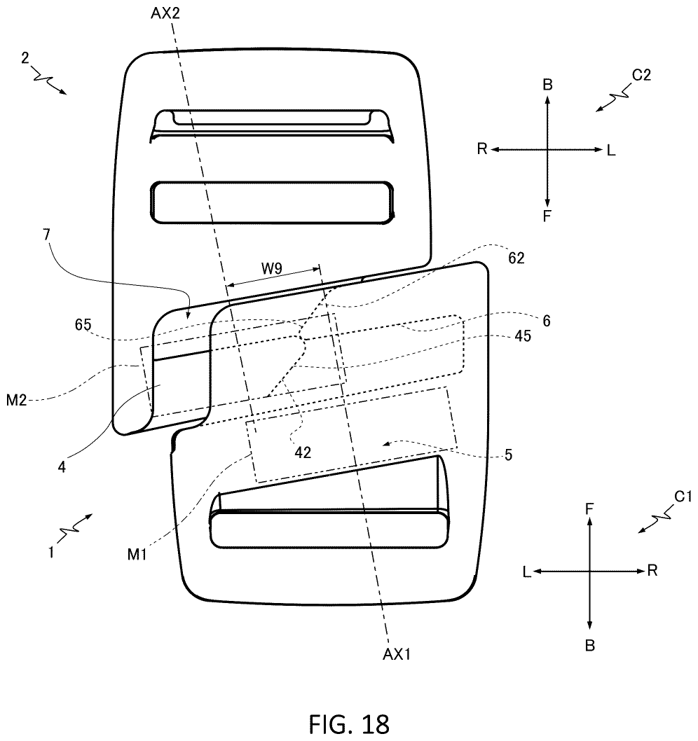

In a state illustrated in FIG. 18, the second end 62 of the male portion 6, 6′ has finished sliding on the guide surface 45 of the male portion 4, 4′ and the second end 62 of the male portion 6, 6′ is positioned at the introduction end 71 of the female groove 7,7′. Likewise, the second end 42 of the male portion 4, 4′ has finished sliding on the guide surface 65 of the male portion 6, 6′ and the second end 42 of the male portion 4 or 4′ is positioned at the introduction end 51 of the female groove 5, 5′. Subsequently, the first and second parts 1, 2 approach each other along the width direction D1 of the buckle 9 in accordance with the magnetic attraction force (i.e. the alignment action of the first and second magnets M1, M2) between the first and second magnets M1, M2 in the radial direction of the magnetic axes AX1 and AX2, the male portion 6, 6′ is inserted into the female groove 7,7′, and the male portion 4, 4′ is inserted into the female groove 5,5′. The respective male portion moves from the introduction end toward the opposite end of the respective groove.

The second end 62 of the male portion 6, 6′ moves along the rounded edge 47 formed between the guide surface 45 and the stopper surface 46 of the male portion 4, 4′. Likewise, the second end 42 of the male portion 4, 4′ moves along the rounded edge 67 formed between the guide surface 65 and the stopper surface 66 of the male portions 6, 6′. The interval W9 between the magnetic axes AX1 and AX2 becomes the maximum value while each of the male portions 4, 4′, 6, and 6′ passes through the above-described edges 47 and 67. Thereafter, as the male portions 6, 6′ are inserted into the female grooves 7, 7′ and the male portion 4, 4′ are inserted into the female grooves 5, 5′, the interval W9 between the magnetic axes AX1 and AX2 gradually decreases. When the interval W9 between the magnetic axes AX1 and AX2 is at the minimum value, the first magnet M1 and the second magnet M2 partially face each other. That is, the left portion (e.g. left half) of the first magnet M1 and the left portion (e.g. left half) of the second magnet M2 face each other with a slight distance in the length direction D3 of the buckle 9. Therefore, even if the interval between the magnetic axes AX1 and AX2 increases, the first and second magnets M1, M2 may remain in a sufficiently magnetically coupled state.

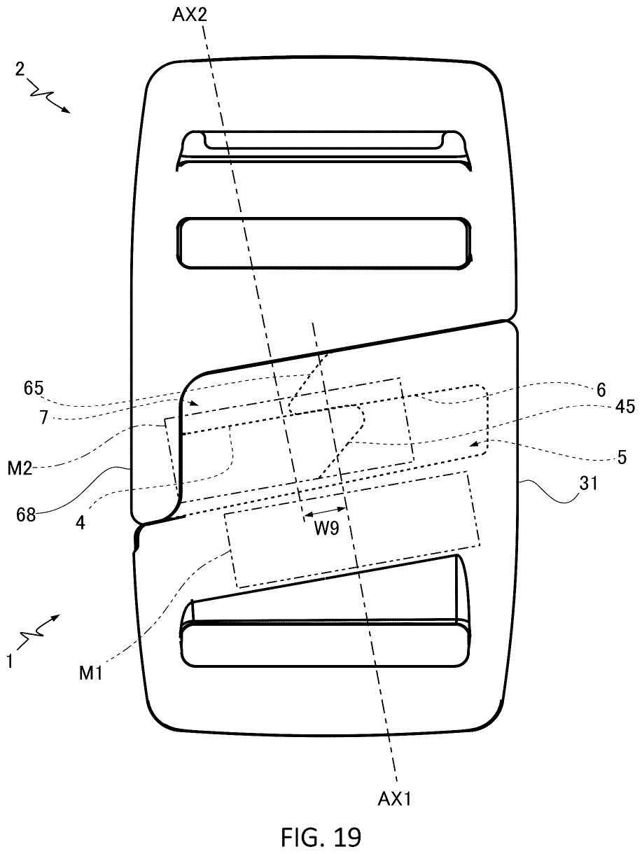

In a state illustrated in FIG. 19, the male portion 6, 6′ has been fully inserted into the female groove 7, 7′ and the male portion 4, 4′ has been fully inserted into the female groove 5, 5′, in accordance with the magnetic attraction force caused between the first and second magnets M1, M2 in the radial direction of the magnetic axes AX1 and AX2 (i.e. an alignment action of the first and second magnets M1, M2). Further, the housing 31 and the stop wall 68 collide with each other (the stop wall 68 is received by the notch 69 of the housing 31), and the first and second parts 1, 2 have been fully coupled.

The stopper surface 66 of the male portions 6, 6′ of the first part 1 may be in contact with the male portion 4, 4′ of the second part 2 to prevent the second part 2 from being displaced in a direction away from the first part 1 in the length direction D3 of the buckle 9. Likewise, the stopper surface 46 of the male portion 4, 4′ of the second part 2 may be in contact with the male portions 6, 6′ of the first part 1 to prevent the first part 1 from being displaced in a direction away from the second part 2 in the length direction D3 of the buckle 9. In this manner, separation (relative displacement) of the first and second buckle parts 1, 2 in the length direction D3 of the buckle 9 is prevented.

Even in the state where the first and second parts 1, 2 have been fully coupled, an interval W9 is kept between the magnetic axes AX1 and AX2, thereby impeding the male portion 6, 6′ from being easily pulled out from the female groove 7, 7′ and impeding the male portion 4, 4′ from being easily pulled out from the female groove 5, 5′. Note that, as described above, the closure wall 63 of the second part 2 is inserted into the gap 16 of the plate-shaped portion 11 of the second part 2, and thus strengthening the coupling between the first and second parts 1, 2.

Methods of producing the buckle parts 1, 2 would be obvious to those skilled in the art in view of the above description, but will be discussed just for a precaution. A method of producing the buckle part 1, 2 includes disposing the first magnet M1 onto a plurality of support bosses 111, 112 provided in a first half cavity 103 of the stationary mold 101, moving a movable mold 102 toward the stationary mold 101 to configure a molding cavity 105 from the first half cavity 103 of the stationary mold 101 and a second half cavity 104 of the movable mold 102; and supplying a molten resin into the molding cavity 105 in a state where the first magnet M1 has been located inside the molding cavity 105. The first magnet M1 is supported by the support bosses 111, 112, and correspondingly the windows K1 and K2 are formed at the injection-molded portion 3. If one or more pusher bosses 121 were provided in the second half cavity 104 of the movable mold 102, the window K3 may be formed at the injection-molded portion 3 correspondingly.

The plurality of support bosses 111, 112 includes the first support boss 111 that is in contact with the first magnet M1 at least in the entire area of the first surface region R1 of the first magnet M1. The first surface region R1 includes the adjacent first and second partial surface regions E1, E2 of the adjacent first and second external surfaces (the lower surface 8d and the left surface 81) of the first magnet M1, and the first edge 35 formed between the adjacent first and second partial surface regions E1, E2. The same applies to the case where the first magnet M1 is a magnetic body, and the same description applies to the production of the second part 2.

When the first magnet M1 is disposed in the first half cavity 103 of the stationary mold 101, a further magnet may be disposed immediately under the predetermined arrangement place for the first magnet M1 in order to appropriately set the alignment of N and S poles of the first magnet M1 in the up-down direction. For example, when a magnetic attraction force is caused between the first magnet M1 and the further magnet, one can find it that the first magnet M1 is appropriately disposed. When a magnetic repulsive force is caused between the first magnet M1 and the further magnet, one can find that the first magnet M1 is improperly disposed.

As would be clear from FIGS. 21 and 22, the windows K1, K2, and K4 are formed corresponding to the contact area between the support boss and the magnet (magnetic body). The window K3 is formed corresponding to the contact area between the pusher boss and the magnet (magnetic body). The specific contour of the window and the three-dimensional spatial shape thereof can be variously modified. The support boss supports the magnet (magnetic body) by touching adjacent partial surface regions of two adjacent external surfaces or adjacent partial surface regions of adjacent three external surfaces of the magnet (magnetic body).

Based on the above teachings, those skilled in the art may make various modifications to each embodiment and each feature. The reference codes incorporated in the claims are for reference only and should not be referred to for a purpose of limiting the scope of claims.

1. A buckle part of a buckle comprising:
an injection-molded portion; and
at least one magnetic body, optionally comprising a magnet, secured and embedded in the injection-molded portion, wherein
the injection-molded portion is shaped such that the magnetic body is partially exposed at least in a first surface region of the magnetic body.

2. The buckle part of claim 1, wherein the magnetic body includes first and second external surfaces which are adjacently located, and
the first surface region includes adjacent first and second partial surface regions and a first edge formed between the adjacent first and second partial surface regions, said first and second partial surface regions being included in said first and second external surfaces respectively.

3. The buckle part of claim 2, wherein the injection-molded portion includes a first window that is recessed at least in a thickness direction of the buckle part so as to expose the first surface region, one of the first and second external surfaces extends along the thickness direction, and the other one of the first and second external surfaces extends so as to cross the thickness direction.

4. The buckle part of claim 3, wherein the magnetic body has a third external surface adjacent to both the first and second external surfaces and extending along the thickness direction of the buckle part, and
the first window is shaped to partially expose the third external surface.

5. The buckle part of claim 4, wherein the injection-molded portion covers a corner of the magnetic body formed at least by the first to third external surfaces.

6. The buckle part of claim 4, wherein the first external surface is a lower surface, the second external surface is a side surface, and the third external surface is a front surface.

7. The buckle part of claim 3, wherein the injection-molded portion includes a second window at a different location from the first window and recessed in a same direction as a direction the first window is recessed at least in a thickness direction of the buckle part so as to partially expose the magnetic body.

8. The buckle part of claim 7, wherein the magnetic body has a second surface region exposed by the second window, and the second surface region includes a partial surface region included in one of the first and second external surfaces.

9. The buckle part of claim 7, wherein the injection-molded portion includes a third window that is recessed in a direction opposite to the direction the first window is recessed at least in the thickness direction of the buckle part so as to partially expose the magnetic body.

10. The buckle part of claim 9, wherein the magnetic body has a third surface region exposed by the third window, and the third surface region includes a partial surface region located on an opposite side of one of the first and second partial surface regions.

11. The buckle part of claim 9, wherein the magnetic body is a hexahedron, and the injection-molded portion is shaped such that five external surfaces except one of the six external surfaces of the hexahedron are partially exposed.

12. The buckle part of claim 1, wherein the magnetic body is a polyhedron, and the injection-molded portion covers all corners of the polyhedron.

13. The buckle part of claim 1, wherein the magnetic body has a width exceeding ½ of a maximum width of the buckle part in a width direction of the buckle part.

14. The buckle part of claim 1, wherein the injection-molded portion includes a webbing attachment portion and an engagement portion connected to the webbing attachment portion, and
the magnetic body is embedded in the engaging portion in such a manner that the magnetic body is partially exposed.

15. The buckle part of claim 14, wherein the magnetic body is a magnet, and the engagement portion includes:
at least one female groove extending along a width direction of the buckle part; and
at least one male portion arranged adjacent to the at least one female groove on one side of the at least one female groove which is a farther side from the webbing attachment portion, and wherein
the at least one male portion is arranged orthogonal to or intersecting with a magnetic axis of the magnet when viewed along the thickness direction of the buckle part.

16. The buckle part of claim 1, wherein the magnetic body is elongated along a width direction of the buckle part, and is embedded in the injection-molded portion so as to be not displaceable in an elongation direction thereof.

17. The buckle part of claim 16, wherein the magnetic body have two external surfaces orthogonal to the elongation direction thereof, one of the two external surfaces is partially covered by the injection-molded portion and the other one is entirely covered by the injection-molded portion.

18. A method of producing a buckle part having at least one magnetic body, the method comprising:
disposing at least one magnetic body, optionally comprising a magnet, onto a plurality of support bosses provided in a first half cavity of a stationary mold;
moving a movable mold toward the stationary mold to configure a molding cavity from the first half cavity of the stationary mold and a second half cavity of the movable mold; and
supplying a molten resin into the molding cavity in a state where the magnetic body has been located inside the molding cavity, wherein
the plurality of support bosses includes a first support boss that is in contact with the magnetic body at least in an entire area of a first surface region of the magnetic body; and
the first surface region includes first and second adjacent partial surface regions of adjacent first and second external surfaces of the magnetic body and a first edge formed between the first and second adjacent partial surface regions.

19. The method of producing a buckle part of claim 18, wherein the plurality of support bosses includes a second support boss that is in contact with the magnetic body at least in an entire area of a second surface region of the magnetic body, and
the second surface region includes a partial surface region included in one of the first and second external surfaces.

20. The method of producing a buckle part of claim 18, wherein the second half cavity has a pusher boss that comes in contact with the magnetic body at least in an entire area of a third surface region of the magnetic body, and
the third surface region includes a partial surface region located on an opposite side of either one of the first and second partial surface regions.
